(19) United States
(12) Patent Application Publication
(10) Pub. No.: US 2022/0067039 A1
(43) Pub. Date: Mar. 3, 2022

(54) METHOD AND SYSTEM FOR RETRIEVING DATA AND DISPLAYING CONTENT DENSITY OF A DATA STORAGE

(71) Applicant: Ahmad Faralem, Kuala Lumpur (MY)

(72) Inventor: Ahmad Faralem, Kuala Lumpur (MY)

(21) Appl. No.: 13/063,593

(22) PCT Filed: Sep. 11, 2009
(86) PCT No.: PCT/MY2009/000144

§ 371 Date: Oct. 10, 2012

(30) Foreign Application Priority Data
Sep. 12, 2008 (MY) PI20083549

(51) Int. Cl. G06F 16/248

(52) U.S. Cl. CPC G06F 16/248

(57) ABSTRACT

The present invention relates to a method and system for retrieving data and displaying content density of a data storage. The data retrieval system of the present invention is essentially comprised of a querying interface, a data storage, a data retrieval component, a retrieved data processing component, and a displaying unit. The data retrieval system further comprises of a data querying and organizing component. The data querying and organizing component is essentially comprised of a first querying member, a second querying member, and an assigning member. The first querying member is essentially adapted to execute a first query to retrieve data from the data storage based on at least a portion of content items in query and the second querying member is adapted to execute a second query to retrieve distinct data from the data storage based on at least a portion of distinct content items in query. The assigning member is adapted to compare records from result of the first query and records from result of the second query, to acquire number of occurrences of each of the records of the second query result into all of the records of the first query result; to assign a frequency weight to each of the records of the second query result according to the acquired frequency of occurrence, and to assign a predefined formatting style to each of the records of the second query result according to the frequency weight of the corresponding record of the second query result. The records of the second query result are displayed in a representation through the displaying unit according to the assigned formatting style. As a result, the content density of the corresponding record of the second query result in the data storage can be portrayed. The method of the present invention generally comprises the steps of querying the data storage, retrieving data from the data storage, processing the retrieved data, and displaying the retrieved data.

### FIELD OF THE INVENTION

The present invention relates to a method and system to present queried content from a data storage.

### BACKGROUND ART

Many systems or web-based applications have been provided with the intention to retrieve data and display content in query from a knowledge base or a data storage in such a manner that the user can select the tags to view more details with regards to the content queried.

However, these systems or applications do not express the intensity of the contents which are available in the data storage to the user. Especially for a literacy tool, it is essential for the user to know at a glance of how much data is available from the data storage/knowledge base. The conventional systems or applications present content in their knowledge base in a format that does not seem to provide much information to the users that assists them to explore for the information comprehensively.

A user using the systems or applications would need to know how much the content in query is available in the data storage so that the querying of content can be performed fruitfully. However, most of the systems or applications only present tags and/or content items that are recommended in response to requests received from computing devices. The tags or content items generated may not be of the user's interest. Moreover, in the case of the recommended tags may be generated in a list, the user would more likely interested to know how much information in query is available in the data storage. The content items are derived based on the measure of times a tag has been associated with a content item. Such systems or applications only employ a recommendation engine to operate and retrieve the data in the data storage when queried.

Such a system to retrieve and present data from a data storage is the subject, for example, of G.B. patent No. 2368249 that describes a data processing apparatus operable to receive symbols from a source having a predetermined symbol set and to generate a weight indicative of a relative frequency of occurrence of each symbol of the set. The data processing apparatus of the invention disclosed comprises a data butter to which the received data symbols are fed, a data store arranged to store data representative of a frequency score for each of the possible data symbols, and a control processor which is arranged in operation to bias the frequency score for each source data symbol from the set received, to adjust the frequency score for at least one of the data symbols within the buffer by an amount determined in dependence upon a relative position of the each data symbol within the buffer, and to generate the weight for each possible data symbol in dependence upon the corresponding frequency score. The data processing apparatus also includes a compression encoder operable to encode the data symbols in dependence upon the weight generated for that symbol, and/or a decompressor.

The above identified system utilizes a weight generated indicative of a relative frequency of occurrence of each symbol of a set received from a source. It is important that the systems or applications is able derive content items from the data storage based on the frequency weight of the queried data in the knowledge base. However, the systems or applications are limited to only project the retrieved data according to the frequency of occurrence but not at the same time the content density of the data in the knowledge base.

It is therefore such a need to provide a system or application that not only project the retrieved data based on the frequency weight of the queried content in the knowledge base but also the content density in the knowledge base to ease the querying by a user.

### SUMMARY OF THE INVENTION

Accordingly, the present invention relates to a method and system for retrieving data and displaying content density of a data storage. In one aspect, a method for retrieving data from a data storage and displaying content density of the data storage essentially comprises of the steps of querying the data storage, retrieving data from the data storage, processing the retrieved data, and displaying the retrieved data.

The step of retrieving data from the data storage is comprised of the steps of executing a first query to retrieve data from the data storage, and executing a second query to retrieve distinct data from the data storage. Said first query is conducted based on at least a portion of content items in query, and said second query is based on at least a portion of distinct content items in query.

The step of processing the retrieved data essentially comprises the steps of comparing records from result of the first query and records from result of the second query; acquiring number of occurrences of each of the records of the second query result into all of the records of the first query result to determine frequency of occurrence of each record of the second query result, assigning frequency weight to each of the records of the second query result based on said acquired frequency of occurrence, and assigning a predefined formatting style to each of the records of the second query result, said formatting style is based on said frequency weight of the corresponding record of the second query result;

Finally, the step of displaying the retrieved data is comprised the step of displaying each of the records of the second query result according to the corresponding formatting style in a representation in such a manner that the content density of the corresponding record of the second query result in the data storage is portrayed.

In another aspect, a data retrieval system is essentially comprised of a querying interface, a data storage, a data retrieval component, a retrieved data processing component, and a displaying unit. The data retrieval system is further comprised of a data querying and organizing component. The data querying and organizing component comprises a first querying member, a second querying member, and an assigning member.

The first querying member is essentially adapted to execute a first query to retrieve data from the data storage based on at least a portion of content items in query. A second querying member is adapted to execute a second query to retrieve distinct data from the data storage based on at least a portion of distinct content items in query. An assigning member is conveniently configured to compare records from result of the first query and records from result of the second query, to acquire number of occurrences of each of the records of the second query result into all of the records of the first query result, to assign a frequency weight to each of the records of the second query result according to the acquired frequency of occurrence, and finally to assign a predefined formatting style to each of the records of the second query result according to the frequency weight of the corresponding record of the second query result.

The records of the second query result would subsequently be displayed in a representation through the displaying unit according to the assigned formatting style such that the content density of the corresponding record of the second query result in the data storage is portrayed.

It is an object of the present invention to facilitate a user to identify how much of data or information in query exists in the data storage.

It is also an object of the present invention to provide a clear presentation of large/small content of records acquired from the data storage. This facilitates that a user can identify whether a tag has high content or low content in query by referring correspondingly to the tag font size or the tag cloud.

It is further an object of the present invention to represent the content density from the data storage in the form of tag clouds with predefined formatting styles assigned to tags. The content density representation implements visualization of contents of a data storage in such a manner that the content density in the data storage can be easily identified.

It is a final object of the present invention to assign formatting style to the tag cloud, tag font size or anything related to the tag in such a manner that the tag is capable to indicate the content density of the tag and to display the result in the form of tag clouds; according to the frequency of occurrence of the second query into the first query.

The present invention consists of certain novel features and a combination of parts hereinafter fully described and illustrated in the accompanying drawings and particularly pointed out in the appended claims; it being understood that various changes in the details may be without departing from the scope of the invention or sacrificing any of the advantages of the present invention.

### BRIEF DESCRIPTION OF THE DRAWINGS

For the purpose of facilitating an understanding of the invention, there is illustrated in the accompanying drawings the preferred embodiments from an inspection of which when considered in connection with the following description, the invention, its construction and operation and many of its advantages would be readily understood and appreciated.

FIG. 1 is a flow chart showing the stages involved in the process of generating the tag clouds.

FIG. 2 is a flow chart showing the core process to form tag clouds.

FIG. 3 is a flow chart showing the entire process to create the tag clouds.

### DETAILED DESCRIPTION OF THE PREFERRED EMBODIMENTS

The present invention relates to a method and system to present queried content from a data storage. More particularly, the present invention relates to a method and system for retrieving data and displaying content density of a data storage. Hereinafter, said method and system shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

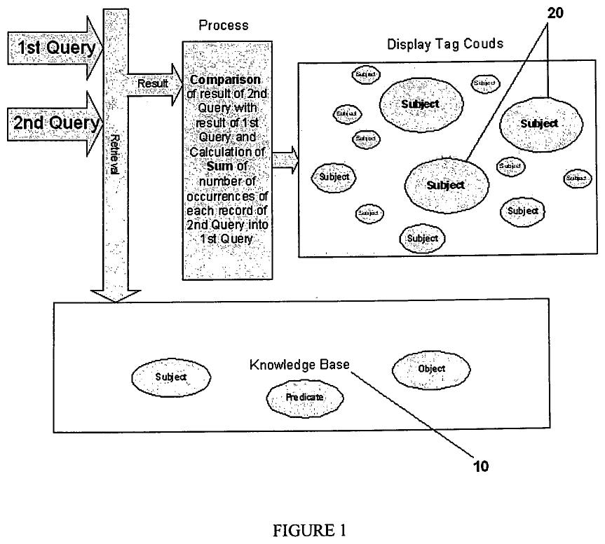

Referring to FIG. 1, a method and system adapted for retrieving data from a data storage and displaying content density therein is hereinafter disclosed. In general, there is a need to represent contents in a knowledge base 10 so that users can explore the information comprehensively. The conventional systems or web-based applications do not express the intensity of contents which is available in the knowledge base 10 to the user. Especially in the literacy tools, it is essential that the users particularly the students can know at a glance of how much data or information is available in the knowledge base 10.

With the presence of the present invention, the above adversaries can be eliminated. The users can be facilitated to distinguish which content is rich and which content is scarce within the knowledge base 10. Furthermore, users are also facilitated to digest easily just by a glimpse that which tag has a higher content associated and which tag has less content associated in the knowledge base 10. It is therefore that the present invention provides such a solution whereby the queried contents in the knowledge base 10 are presented in the form of tag clouds 20. The users can discover how much content is associated with the specific content item in the knowledge base 10.

Tag clouds 20 in general are a visual (weighted list) representation pf information available in the knowledge base 10. The tag clouds 20 are normally generated by means of acquiring the frequency of occurrence and later assigning a frequency weight to the records from the result. As such, it would be easily identified how much of information exists in the knowledge base 10. It is appreciably a normal practice of the present invention to implement different font size on the tags or the size of the tag clouds. As an example, if the tag font size is adapted small, this denotes that the information regarding the particular tag is very less and if the tag font size is big, the information regarding the particular tag is extra more.

In one aspect, the method is conducted in a data retrieval system comprising a data storage. The method generally comprises the steps of querying the data storage, retrieving data from the data storage, processing the retrieved data, and displaying the retrieved data. It is very much preferred that in the present invention, the knowledge base 10 is adapted as the data storage.

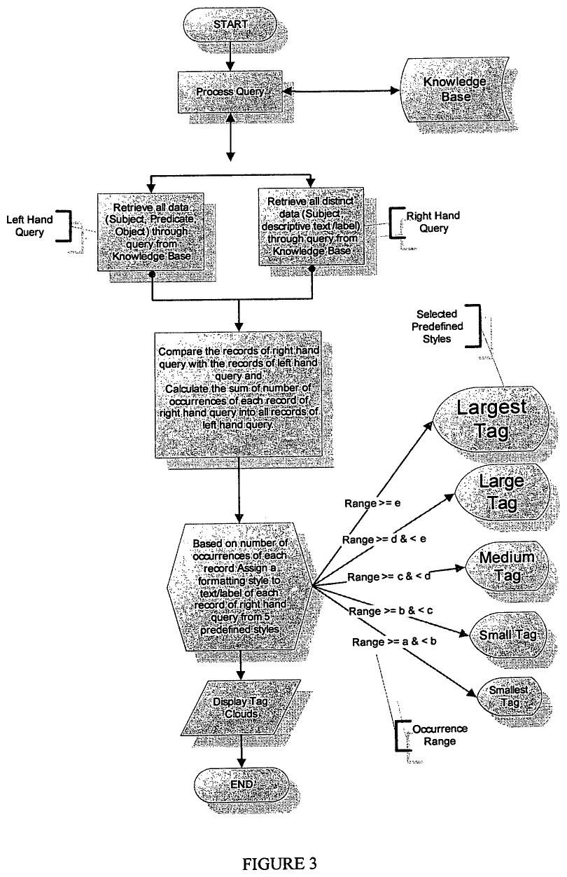

With reference to FIGS. 1 and 3, in the step of retrieving data from the knowledge base, a first query would preferably be executed to retrieve data from the knowledge base 10 based on the content items in query. Next, a second query would then be executed to retrieve distinct data from the knowledge base 10 based the distinct content items in query.

In the first query, all the data each comprising a subject, a predicate, and an object are retrieved from the knowledge base 10. In the second query, the distinctive data comprising a subject and a descriptive text or label would be retrieved from the knowledge base 10. The first query and the second query are adapted to be conducted correspondingly one after another or simultaneously depending on the preferred embodiment.

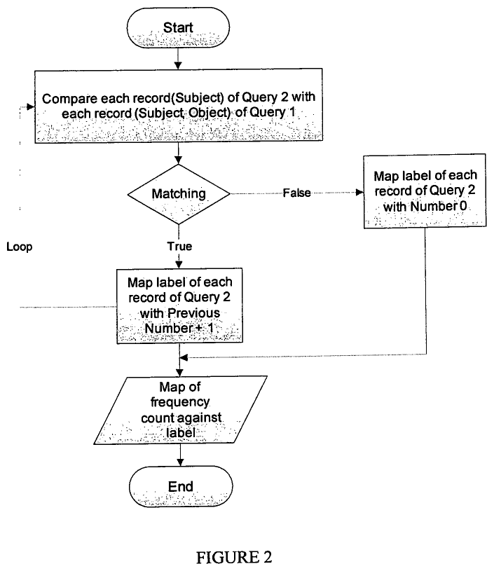

The number of occurrences of each of the records of the second query result into all of the records of the first query result would then be acquired so that the frequency of occurrence of each record of the second query result would be determined. Referring now to FIG. 2, there is a methodology practiced in the present invention to compare the results from the second query with the first result of the first query. For each particular record (Subject) of the result of the second query, a comparison would be made with the result of the first query to calculate the sum of number of occurrences of each particular record (Subject) of result of the second query into the result of the first query. In the comparison of both records from the result of the first query and the second query, each record of the second query result would be matched to each record of the first query result to calculate the number of occurrence based on the match. It is appreciated that if both corresponding records do not match, the label of each record of the second query result is mapped with number ‘0’; or if both corresponding records match with each other, the number of matched records would be acquired, the label of each record of the second query result is then mapped with the previously acquired number of matched records, and finally the frequency count is mapped against the label.

Then, the method of the present invention would proceed to the step of assigning frequency weight to each of the records of the second query result based on said acquired frequency of occurrence. Based on the number of occurrences of each record of the second query result, the calculated weight (number of occurrences) would be assigned to each record of the second query result. In addition, it is preferred that all the records of the second query result are sorted based on the descriptive text or label of said records. The descriptive text or label is also adapted as a tag for representing the corresponding record of the second query result.

Based on the number of occurrences or the frequency weight, a formatting style would be assigned to the text/label of each record of the second query result. The formatting style can be implemented on the tag font size or the size of the tag cloud; or both together at the same time. It is also preferred that the formatting style is implemented on any other elements to be displayed in a representation for presenting the content density of a queried content in the knowledge base 10.

The predefined formatting style is preferably assigned to the descriptive text or label such that the font size of the tag can be implemented based on the frequency of the record of the second query result. It is essential that the tag font size is adapted to correspond with the content density of the record of the second query result in the knowledge base 10. Preferably, as a result of the formatting style, relatively larger the tag font size of the corresponding tag would be implemented to indicate higher content density of the record of the second query result in the knowledge base 10 of said tag. The relatively smaller the tag font size of the corresponding tag would be implemented to indicate the lower content density of the record of the second query result in the knowledge base 10 of said tag.

As aforementioned, the predefined formatting style can also be implemented on the tag clouds 20 of each record of the second query result depending on the preferred embodiments. As a result, the records from the second query in the form of tag clouds 20 are displayed according to the formatting style assigned to each of the records of the second query result. It is essential that the tag clouds 20 each represent each record of the second query result. It is also essential that the predefined formatting style is assigned to the tag cloud of each of the records of the second query result based on the frequency of the respective corresponding record. The formatting style would then facilitate the portrayal of the content density of the corresponding record of the second query result in the display later. Also, the size of the tag cloud 20 is adapted to correspondingly indicate the content density of the record of the second query result in the knowledge base 10. The method is preferably configured to indicate relatively larger size of the tag cloud 20 that represents higher content density of the record of the second query result in the knowledge base 10 and to indicate relatively smaller size of the tag cloud 20 that represents lower content density of the record of the second query result in the knowledge base 10.

Later, the method of the present invention appreciably proceeds to the step of displaying the retrieved data. Each of the records of the second query result is displayed according to the corresponding formatting style in the representation. The step is essentially conducted to portray the content density of the corresponding record of the second query result in the knowledge base 10. It is also preferred that the tag clouds are generated using HTML elements. The records from the second query are preferred to be generated and displayed in the form of tag clouds 20 using Ontology database.

In another aspect, a data retrieval system comprising a querying interface, a data storage, a data retrieval component, a retrieved data processing component; and a displaying unit is disclosed. In the data retrieval system of the present invention, a knowledge base 10 is preferably adapted as the data storage. The data retrieval system is adapted in the present invention to further comprise a data querying and organizing component.

It is preferred that the data querying and organizing component to comprise a first querying member, a second querying member, and an assigning member. It is essential that the first querying member is adapted to execute a first query to retrieve data (Subject, Predicate, Object) from the knowledge base 10 based on the content items in query. The second querying member is essentially adapted to execute a second query to retrieve distinct data (Subject, Descriptive text/label) from the knowledge base 10 based on the distinct content items in query.

The assigning member is preferably adapted to compare records from result of the first query and records from result of the second query, to acquire frequency of occurrence of each of the records of the second query result into all of the records of the first query result; to assign a frequency weight to each of the records of the second query result according to the acquired frequency of occurrence, and finally to assign a predefined formatting style to each of the records of the second query result according to the frequency weight of the corresponding record of the second query result. The records of the second query result are displayed in a representation through the displaying unit according to the assigned formatting style such that the content density of the corresponding record of the second query result in the knowledge base 10 is portrayed.

Referring again to FIG. 2, the frequency of occurrence of each record of the second query result into all of the records of the first query result would be calculated based on the comparison result of the two queries' records. In the comparison of the records from the result of both of the queries, each record (Subject) of the second query result would be matched to each record of the first query result. It is preferably adapted that if both corresponding records do not match, the label of each record of the second query result is mapped with number ‘0’; or if both corresponding records match with each other, the number of matched records would be acquired, the label of each record of the second query result is then mapped with the previously acquired number of matched records, and finally the frequency count is mapped against the label.

In the present invention, it is very much preferred that the descriptive text or label is adapted as a tag for representing the corresponding record of the second query result. The descriptive text or label of each of the records of the second query result is later assigned with a predefined formatting style based on the frequency of the respective corresponding record. As a result, the content density of the corresponding record of the second query result can be portrayed in the representation. In addition, all the records of the second query result would be sorted based on the descriptive text or label of said records.

When the number of occurrences is acquired for a corresponding record of the second query result, the frequency of occurrence then would be derived therefrom and the corresponding frequency weight would be assigned to said corresponding record of the second query result.

Next, the descriptive text or label is preferably assigned with a predefined formatting style to implement font size of the tag according to the frequency of the record of the second query result. The tag font size is essentially adapted to correspond to the content density of the record of the second query result in the knowledge base 10. The relatively larger the tag font size of the corresponding tag is adapted to correspondingly indicate the higher content density of the record of the second query result in the knowledge base 10 of said tag whereas the relatively smaller tag font size of the corresponding tag is adapted to correspondingly indicate the lower content density of the record of the second query result in the knowledge base 10 of said tag.

It is also appreciated that the records from the second query are displayed in the form of tag clouds 20 according to the formatting style assigned to each of the records of the second query result. It is adapted in the present invention that the tag clouds 20 each would represent each record of the second query result. Besides the tag font size, it is essential for the predefined formatting style to be also assigned to the tag cloud of each of the records of the second query result in accordance to the determined frequency of the respective corresponding record of the second query result.

The predefined formatting style is assigned to the corresponding record of the second query result to implement the size of the tag cloud 20 such that the content density of the record of the second query result in the knowledge base 10 can be represented by the size of the tag cloud 20. It is preferably adapted in the present invention that the relatively larger size of the tag cloud 20 would indicate correspondingly the higher content density of the record of the second query result in the knowledge base 10 whereas the relatively smaller size of the tag cloud 20 would indicate correspondingly the lower content density of the record of the second query result in the knowledge base 10.

With reference to the FIG. 3 again, it is preferred that a number of predefined formatting styles are created. The predefined formatting styles each would cater for a predetermined range of number of occurrences in which a record of the second query result could fall into. A particular record of the second query result would therefore be assigned with the appropriate predefined formatting style based on the range of the number of occurrences, said particular record falls into

It is preferred that there are a number of categories for displaying the tags in the tag clouds based on the predefined formatting styles. The tags are appreciably formatted as follows:
a) Smallest Tag (≥a & <b occurrence)
b) Small Tag (≥& <c occurrence)
c) Medium Tag (≥c & <d occurrence)
d) Large Tag (≥d & <e occurrence)
e) Largest Tag (≥e occurrence)

Where a, b, c, d, e are the predefined formatting ranges depending on the preferred embodiment of the present invention.

According to the number of occurrences of each record of the second query result, the tag clouds display the tags (descriptive text/label) of each record of the second queries result according to the predefined formatting styles for each range. The ranges of the number of occurrences of the above listed tags are arranged in an increasing order. The number of categories, however, may be reduced or extended depending on the most preferred embodiment of the present invention.

While in the foregoing specification this invention has been described in relation to certain preferred embodiments thereof and many details have been set forth for purpose of illustration, it will be apparent to those skilled in the art that the invention is susceptible to additional embodiments and that certain of the details described herein can be varied considerably without departing from the basic principles of the invention.

1. A method for retrieving data from a data storage and displaying content density of the data storage, the method is conducted in a data retrieval system; the method comprises the steps of querying the data storage; retrieving data from the data storage; processing the retrieved data; and displaying the retrieved data; characterized in that the step of retrieving data from the data storage comprises the steps of:
executing a first query to retrieve data from the data storage, said first query is conducted based on at least a portion of content items in query; and —executing a second query to retrieve distinct data from the data storage, said second query is based on at least a portion of distinct content items in query;
the step of processing the retrieved data comprises the steps of:
comparing records from result of the first query and records from result of the second query; —acquiring number of occurrences of each of the records of the second query result into all of the records of the first query result to determine frequency of occurrence of each record of the second query result; assigning frequency weight to each of the records of the second query result based on said acquired frequency of occurrence; and—assigning a predefined formatting style to each of the records of the second query result, said formatting style is based on said frequency weight of the corresponding record of the second query result;
and the step of displaying the retrieved data comprises the step of:
displaying each of the records of the second query result according to the corresponding formatting style in a representation in such a manner that the content density of the corresponding record of the second query result in the data storage is portrayed.

2. A method for retrieving data from a data storage and displaying content density of the data storage as claimed in claim 1, wherein a knowledge base (10) is adapted as the data storage of the data retrieval system.

3. A method for retrieving data from a data storage and displaying content density of the data storage as claimed in claim 2, wherein the content items of the first query each comprise a subject, a predicate and an object identified from the queried content.

4. A method for retrieving data from a data storage and displaying content density of the data storage as claimed in claim 2, wherein the distinct content items of the second query each comprise a subject and at least one descriptive text or label.

5. A method for retrieving data from a data storage and displaying content density of the data storage as claimed in claim 1, wherein the descriptive text or label is adapted as a tag for representing the corresponding record of the second query result.

6. A method for retrieving data from a data storage and displaying content density of the data storage as claimed in claim 1, wherein the step of assigning a predefined formatting style to each of the records of the second query result further comprises the step of assigning a predefined formatting style to the descriptive text or label of each of the records of the second query result based on the frequency of the respective corresponding record, in order to facilitate the portrayal of the content density of the corresponding record of the second query result in the representation.

7. A method for retrieving data from a data storage and displaying content density of the data storage as claimed in claim 6, wherein all the records of the second query result are sorted based on the descriptive text or label of said records.

8. A method for retrieving data from a data storage and displaying content density of the data storage as claimed in claim 7, wherein the predefined formatting style is assigned to the descriptive text or label to implement font size of the tag based on the frequency of the record of the second query result such that the tag font size is adapted to correspond to the content density of the record of the second query result in the knowledge base.

9. A method for retrieving data from a data storage and displaying content density of the data storage as claimed in claim 8, wherein the relatively larger the tag font size of the corresponding tag correspondingly indicates the higher content density of the record of the second query result in the knowledge base of said tag whereas the relatively smaller the tag font size of the corresponding tag correspondingly indicates the lower content density of the record of the second query result in the knowledge base of said tag.

10. A method for retrieving data from a data storage and displaying content density of the data storage as claimed in claim 5, wherein the step of displaying each of the records from the second query comprises the step of displaying the records from the second query in the form of a plurality of tag clouds according to the formatting style assigned to each of the records of the second query result characterized in that the tag clouds each represent each record of the second query result.

11. A method for retrieving data from a data storage and displaying content density of the data storage as claimed in claim 10, wherein the step of assigning a predefined formatting style to each of the records of the second query result further comprises the step of assigning a predefined formatting style to the tag cloud of each of the records of the second query result based on the frequency of the respective corresponding record, in order to facilitate the portrayal of the content density of the corresponding record of the second query result in the representation.

12. A method for retrieving data from a data storage and displaying content density of the data storage as claimed in claim 11, wherein the size of the tag cloud indicates the content density of the record of the second query result in the knowledge base.

13. A method for retrieving data from a data storage and displaying content density of the data storage as claimed in claim 12, wherein the relatively larger size of the tag cloud indicates correspondingly the higher content density of the record of the second query result in the knowledge base whereas the relatively smaller size of the tag cloud indicates correspondingly the lower content density of the record of the second query result in the knowledge base.

14. A method for retrieving data from a data storage and displaying content density of the data storage as claimed in claim 12, wherein the tag clouds are generated using HTML elements.

15. A method for retrieving data from a data storage and displaying content density of the data storage as claimed in claim 12, wherein the records from the second query are generated and displayed in the form of tag clouds using Ontology database.

16. A method for retrieving data from a data storage and displaying content density of the data storage as claimed in claim 1, wherein the step of comparing records from result of the first query and records from result of the second query comprises the step of matching each record of the second query result to each record of the first query result.

17. A method for retrieving data from a data storage and displaying content density of the data storage as claimed in claim 16, wherein if both corresponding records do not match, the label of each record of the second query result is mapped with number ‘0’; or if both corresponding records match with each other, the number of matched records is acquired, the label of each record of the second query result is then mapped with the previously acquired number of matched records, and finally the frequency count is mapped against the label.

18. A method for retrieving data from a data storage and displaying content density of the data storage as claimed in claim 1, wherein a plurality of predefined formatting styles are created characterized in that the formatting styles each correspond to a predetermined range of the number of occurrences; and a particular record of the second query result would be assigned with the appropriate predefined formatting style according to the range of the number of occurrences in which said particular record falls into.

19. A data retrieval system comprising a querying interface, a data storage; a data retrieval component; a retrieved data processing component; and a displaying unit; characterized in that the data retrieval system further comprises of a data querying and organizing component having:
a first querying member adapted to execute a first query to retrieve data from the data storage based on at least a portion of content items in query;
a second querying member adapted to execute a second query to retrieve distinct data from the data storage based on at least a portion of distinct content items in query; an assigning member adapted to compare records from result of the first query and records from result of the second query; to acquire frequency of occurrence of each of the records of the second query result into all of the records of the first query result; to assign a frequency weight to each of the records of the second query result according to the acquired frequency of occurrence; and to assign a predefined formatting style to each of the records of the second query result according to the frequency weight of the corresponding record of the second query result, wherein the records of the second query result are displayed in a representation through the displaying unit according to the assigned formatting style such that the content density of the corresponding record of the second query result in the data storage is portrayed.

20. A data retrieval system as claimed in claim 19, wherein the data storage is a knowledge base.

21. A data retrieval system as claimed in claim 19, wherein the content items in the first query each comprise a subject, a predicate and an object.

22. A data retrieval system as claimed in claim 19, wherein the distinct content items of the second query each comprise a subject and a descriptive text or label.

23. A data retrieval system as claimed in claim 19, wherein the descriptive text or label is adapted as a tag for representing the corresponding record of the second query result.

24. A data retrieval system as claimed in claim 19, wherein the predefined formatting style is assigned to the descriptive text or label of each of the records of the second query result based on the frequency of the respective corresponding record, in order to facilitate the portrayal of the content density of the corresponding record of the second query result in the representation and all the records of the second query result are sorted based on the descriptive text or label of said records.

25. A data retrieval system as claimed in claim 24, wherein the descriptive text or label is assigned with a predefined formatting style to implement font size of the tag according to the frequency of the record of the second query result so that the tag font size is adapted to correspond to the content density of the record of the second query result in the knowledge base.

26. A data retrieval system as claimed in claim 25, wherein the relatively larger the tag font size of the corresponding tag correspondingly indicates the higher content density of the record of the second query result in the knowledge base of said tag whereas the relatively smaller tag font size of the corresponding tag correspondingly indicates the lower content density of the record of the second query result in the knowledge base of said tag.

27. A data retrieval system as claimed in claim 19, wherein the records from the second query are displayed in the form of a plurality of tag clouds according to the formatting style assigned to each of the records of the second query result characterized in that the tag clouds each represent each record of the second query result.

28. A data retrieval system as claimed in claim 27, wherein the predefined formatting style is assigned to the tag cloud of each of the records of the second query result according to the determined frequency of the respective corresponding record of the second query result in the representation.

29. A data retrieval system as claimed in claim 28, wherein the size of the tag cloud indicates the content density of the record of the second query result in the knowledge base.

30. A data retrieval system as claimed in claim 29, wherein the relatively larger size of the tag cloud indicates correspondingly the higher content density of the record of the second query result in the knowledge base whereas the relatively smaller size of the tag cloud indicates correspondingly the lower content density of the record of the second query result in the knowledge base.

31. A data retrieval system as claimed in claim 19, wherein in the stage of comparison of records of the first query result and records of the second query result, each record of the second query result is matched to each record of the first query result characterized in that if both corresponding records do not match, the label of each record of the second query result is mapped with number ‘0’; or if both corresponding records match with each other, the number of matched records is acquired, the label of each record of the second query result is then mapped with the previously acquired number of matched records, and finally the frequency count is mapped against the label.

32. A data retrieval system as claimed in claim 19, wherein a plurality of predefined formatting styles are created characterized in that the formatting styles each correspond to a predetermined range of the number of occurrences; and a particular record of the second query result would be assigned with the appropriate predefined formatting style according to the range of the number of occurrences in which said particular record falls into.
